(19) United States
(12) Patent Application Publication
(10) Pub. No.: US 2011/0120233 A1
(43) Pub. Date: May 26, 2011

(54) ADAPTER FOR MEASURING TORQUE VALUE

(76) Inventor: CHIA-MING LI, Taichung City (TW)

(21) Appl. No.: 12/647,424

(22) Filed: Dec. 25, 2009

(30) Foreign Application Priority Data
Nov. 20, 2009 (TW) 098221688

(51) Int. Cl. G01L 3/00

(52) U.S. Cl. 73/862.338

(57) ABSTRACT

An adapter of the present invention includes a torsion rod for transferring torsion force between two tools/workpieces. The torsion rod has at least one arc surface disposed on its periphery. The arc surface and the torsion rod are concentric. A strain meter is disposed on the arc surface, and a displayer connects to the strain meter. As such, the adapter of the present invention can measure the torque value more precisely.

### BACKGROUND OF THE INVENTION

1. Field of the Invention

The present invention relates to an adapter, and more particularly to an adapter for transferring torsion force between two tools/workpieces.

2. Description of the Prior Art

A conventional adapter disclosed in TW M367059 is provided with a plain surface where a strain meter is disposed. The strain meter is used to measuring the torque value. However, the stress on the plain surface does not spread uniformly, thus lowering the accuracy of the strain meter.

### SUMMARY OF THE INVENTION

The main object of the present invention is to provide an adapter for measuring a torque value more precisely.

To achieve the above and other objects, an adapter of the present invention includes a torsion rod for transferring torsion force between two tools/workpieces. The torsion rod has at least one arc surface disposed on its periphery. The arc surface and the torsion rod are concentric. A strain meter is disposed on the arc surface, and a displayer connects to the strain meter. As such, the adapter of the present invention can measure the torque value more precisely.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a transparent view showing an adapter of the present invention;

FIG. 2 is a breakdown drawing showing an adapter of the present invention;

FIG. 2A is a perspective view showing a torsion rod of the present invention at another angle of view;

FIG. 3 is a plain view showing a torsion rod of the present invention;

FIG. 4 is a partial profile of a torsion rod of the present invention;

FIG. 5 is a perspective view showing another adapter of the present invention.

### DETAILED DESCRIPTION OF THE PREFERRED EMBODIMENTS

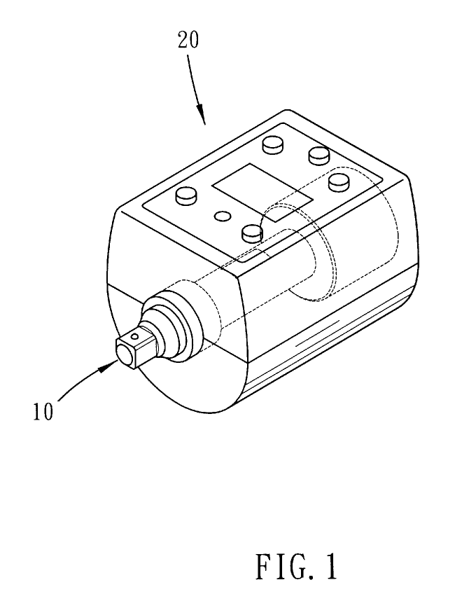

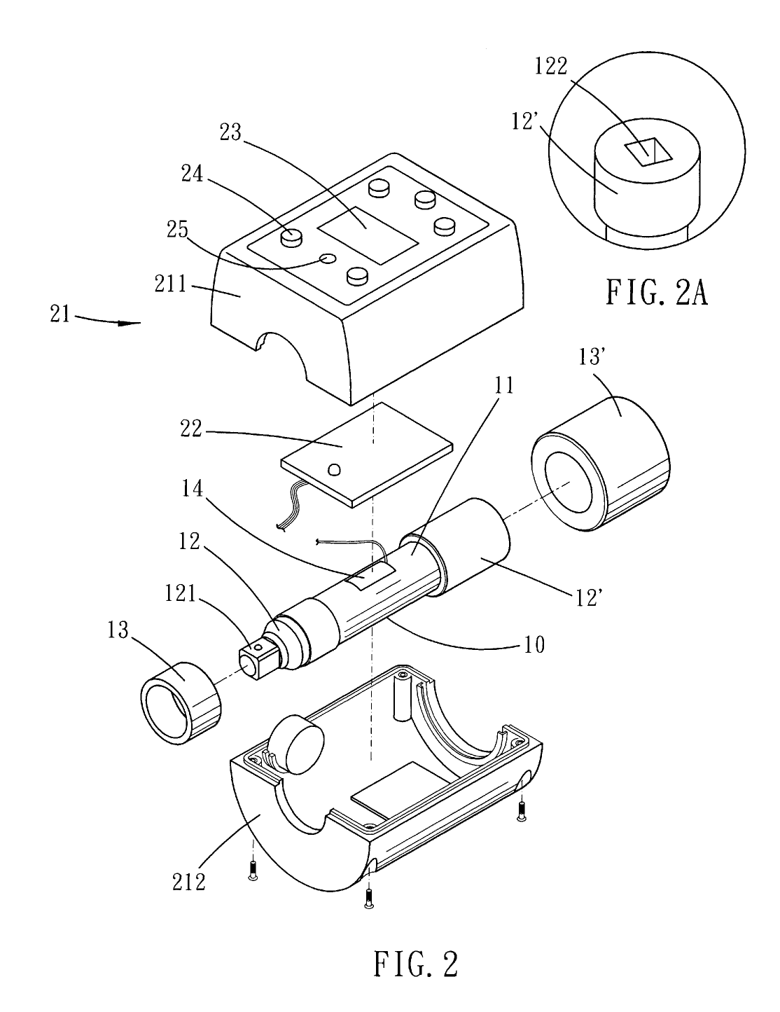

Please refer to FIG. 1 and FIG. 2. An adapter for measuring a torque force between two tools/workpieees is provided. The adapter includes a torsion rod 10 and a displayer 20. The torsion rod 10 may be a cylinder as shown in the drawings, or it may be formed into other shape. Preferably, the torsion rod 10 is made of metal. At least one arc surface 11 is disposed on a periphery of the torsion rod 10, and the are surface 11 and the torsion rod 10 are concentric. Both ends of the torsion rod 10 are formed with a working portion 12, 12′ respectively. As shown in FIG. 2 and FIG. 2A, the working portion 12 has a hexagonal pole 121, and the working portion 12′ has a non circular bore 122. The working portions 12 and 12′ are also concentric. As such, each of the working portions 12 and 12′ can be engaged with a tool or a workpiece.

Each working portion 12, 12′ can be sleeved with a gasket 13, 13′ which is tube shaped. The gaskets 13 and 13′ are also made of metal similar to the torsion rod. A strain meter 14 is disposed on the arc surface 11 of the torsion rod 10. An electronic characteristic, such as the resistance value, of the strain meter 14 varies in correspondence to the strain variation of the arc surface. An adhesive layer 16 is coated between the strain meter 14 and the torsion rod 10, so as to bond the strain meter 14 to the torsion rod 10. Because the arc surface 11 has an axis being exactly the axis of the torsion rod 10, the stress can uniformly applied on the arc surface 11. Therefore, the accuracy of the strain meter 14 can be maintained.

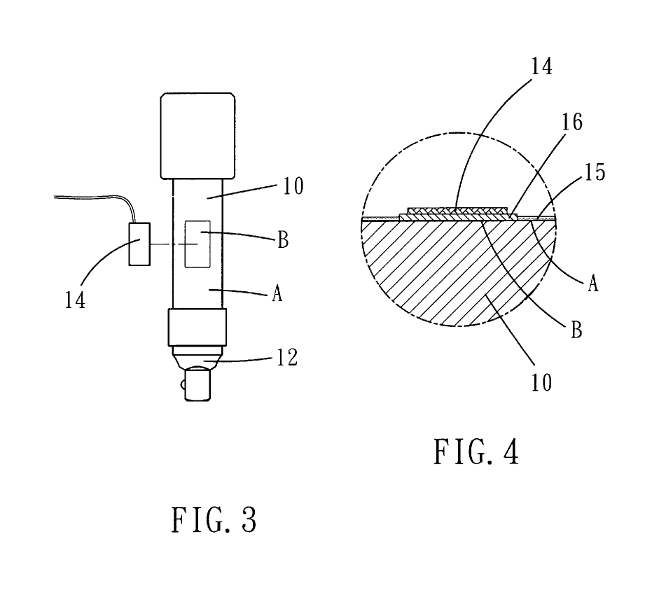

Please refer to FIG. 3 and FIG. 4. The periphery of the torsion rod 10 consists of a treated area A and a non-treated area B. The treated area A is an area treated by electroplating treatment, anodizing treatment or coating treatment to form a protection layer 15. The non-treated area B is disposed on the arc surface 11, and the strain meter 14 is disposed on the non-treated area B so that the strain measurement will not be affected by the surface treatment material. Please refer to FIG. 4, the adhesive layer 16 fully covers the non-treated area 16. As such, the periphery of the torsion rod 10 is coated with the adhesive layer 16 and the protection layer 15, so as to protect the torsion rod 10 from oxidation.

Please refer to FIG. 2. The displayer 20 includes a shell member 21, a circuit board 22, a screen 23, a control element 24 and a lighting element 25. The shell member 21 may consist of an upper shell 211 and a lower shell 212 fitted together. The shell member 21 defines a receiving space and two concentric holes, both of which communicate with the receiving space. The torsion rod 10 and the circuit board 22 are disposed in the receiving space, and the working portions 12 and 12′ extend out of the holes respectively. In addition, the gaskets 13 and 13′ are disposed between the working portions 12 and 12′ and the holes respectively. The gaskets are replaceable, i.e. the thickness of the gaskets can be adjusted so that the shell 21 can be adapted for torsion rods with different sizes. The circuit board 22 has a control circuit, and the circuit board 22 connects to the strain meter 14, the screen 23, the control element 24, the lighting element 25 and a power supply. As such, the control circuit is adapted to receive a signal from the strain meter 14 and to process such signal into a torque value which shows on the screen 23. The control element 24 includes at least one button for the user to operate and to set parameters such as a critical torque value. Once the torque value measured from the torsion rod meets or exceeds the critical torque value, the control circuit can turn on the lighting element 25 such as an LED set for warning purposes.

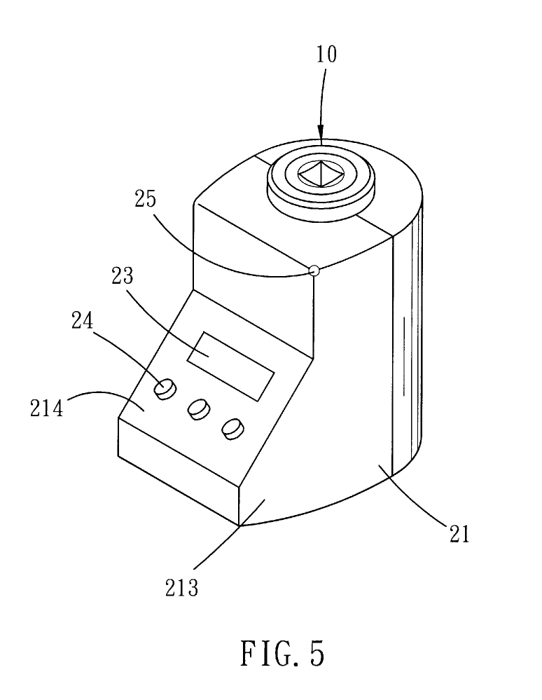

Please refer to FIG. 5. The outer periphery of the shell 21 is formed with an operating surface 214 disposed on a protrusive member 213. The operative surface 214 is not parallel to an orientation of the torsion rod 10. That is, the operative surface 214 is slanted with respect to the axis of the rod 10. At least one of the screen 23 and the control element 24 is disposed on the operating surface 214. In the present embodiment, both the screen 23 and the control element 24 are disposed on the operating surface 214. The lighting element 25 is disposed on one end of the shell 21. Preferably, the lighting element 25 is disposed away from the operating surface 214. As such, the slanted operating surface 214 can provide the user with a better view of the screen 23 and the control element 24.

What is claimed is:

1. An adapter for measuring torque value, comprising:
a torsion rod, having at least one arc surface disposed on its periphery, the torsion rod and the arc surface being concentric, the torsion rod being formed with two working portions at both ends thereof respectively;
a strain meter, disposed on the arc surface;
a displayer, connecting to the strain meter; wherein the displayer comprises a shell member, a circuit board, a screen and a control element, the shell member defines a receiving space and two concentric holes, both of which communicate with the receiving space, the torsion rod and the circuit board are disposed in the receiving space, the working portions extend out of the holes respectively, the circuit board connects to the strain meter, the screen and the control element, the screen and the control element are disposed on an outer periphery of the shell member, the control element comprises at least one button, the circuit board has a control circuit for receiving a signal from the stain meter and processing such signal into a torque value which shows on the screen;
wherein two gaskets are disposed between the working portions and their corresponding holes respectively.

2. The adapter of claim 1, wherein the periphery of the torsion rod consists of a treated area and a non-treated area, the non-treated area is disposed on the arc surface, the strain meter is disposed on the non-treated area.

3. The adapter of claim 2, wherein the working portions are concentric.

4. The adapter of claim 2, wherein a part of the periphery of the torsion rod is coated with an adhesive layer, the adhesive layer bonds the strain meter to the torsion rod, the adhesive layer fully covers the non-treated area.

5. The adapter of claim 1, wherein the working portions are concentric.

6. The adapter of claim 1, wherein the gaskets and the torsion rod are made of metal.

7. The adapter of claim 1, wherein the outer periphery of the shell is formed with an operating surface which is not parallel to an orientation of the torsion rod, at least one of the screen and the control element is disposed on the operating surface.
